(19) United States
(12) Patent Application Publication
(10) Pub. No.: US 2026/0284814 A1
(43) Pub. Date: Sep. 24, 2026

(54) Machining machine

(71) Applicant: Precitrame Machines SA, Tramelan (CH)

(72) Inventors: Vincent ROBERT, Savagnier (CH); Fabrice DROZ, Lajoux (CH); David BURKHALTER, Delémont (CH)

(73) Assignee: Precitrame Machines SA, Tramelan (CH)

(21) Appl. No.: 19/566,476

(22) Filed: Mar. 13, 2026

(30) Foreign Application Priority Data
Mar. 20, 2025 (EP) 25165165.9

(51) Int. Cl. B23Q 7/04

(52) U.S. Cl. CPC B23Q 7/047; B23Q 2230/006

(57) ABSTRACT

The invention relates to a machine for machining parts comprising a frame (1) and a tool spindle (2) designed to carry a tool (2a). The machine also comprises a main workpiece holder (3) designed to hold a workpiece (4), movable relative to the tool spindle, in translation along three axes X, Y, and Z that are not parallel to each other, and in rotation along an axis B, the main workpiece holder (3) being mounted on a cradle (5b) integral with a hollow shaft (5a) movable in rotation about the axis B. The machine also includes a secondary workpiece support (6) that can be actuated by control means between a position of engagement in contact with the workpiece (4) and a position of disengagement without contact with the workpiece. Remarkably, the machine also comprises a finishing unit (10) housed at least partially in the hollow shaft (5a) and extending through an opening (5c) in the cradle (5b), said finishing unit (10) comprising a sliding rod (11) movable in translation along axis B between a retracted position and an extended position, the secondary workpiece support (6) being kinematically connected to the sliding rod (11).

### TECHNICAL FIELD

The present invention relates to a machining machine. More specifically, it relates to a machining machine comprising a finishing unit for completing the machining of the workpiece on the same machining spindle.

### STATE OF THE ART

Machining a workpiece in a machine tool requires the workpiece to be held rigidly in a workpiece holder during material removal operations. The part of the workpiece that is held in place is not accessible for machining. In order to finish the workpiece without having to transfer it to another machining station, a reworking device must be provided within the machine itself to modify the clamping of the workpiece and make the last face accessible.

Application EP1175278 discloses a machine suitable for machining parts, which comprises a first workpiece holder and a movable device equipped with a clamp for gripping the already machined part and performing an additional machining operation. However, the installation of such a device takes up a lot of space and is not easily adaptable, particularly in micro-machines where the volume of the machining area is limited.

Application EP4461458 presents a five-axis micro machining machine that includes a secondary workpiece holder equipped with a clamp designed to grip the machined workpiece at the end of a bar. The secondary workpiece holder is fixed to the Y-axis slide and has no particular kinematics. This configuration uses the existing rotation of the main workpiece holder to a 90° transfer position where the workpiece can be gripped by the secondary workpiece holder's clamp. It is then possible to cut the bar and finish machining the last face. Although it can be implemented within the working volume of a micro machine, this solution has several limitations. The secondary workpiece holder remains permanently in the working volume and limits the rotation of the workpiece cradle around the B axis. Machining is carried out while the workpiece and tool are between the open jaws of the secondary workpiece holder's gripper, which requires a large gripper opening, limits the tool's movement around the workpiece, and increases the risk of collision. The permanent presence of the collet near the workpiece also limits accessibility to the workpiece for loading and unloading, maintenance, or visual inspection. Once the part has been transferred to the secondary workpiece holder, the end of the machining operation is carried out on only three translation axes, while the last face is in an unfavorable position, parallel to the machining spindle, which greatly limits the possibilities for producing complex geometries.

Applications US2015367468 and EP4299242 describe five-axis machining machines in which a rotary support is designed to hold a workpiece on a support while allowing it a degree of freedom in rotation. This makes it possible to contour the workpiece. The rotating support is mounted on the machine cradle, which has the disadvantages of increasing its inertia and taking up space in the work area.

The objective of the invention is to remedy the various disadvantages of the prior art in order to improve the integration of a secondary workpiece support in a multi-axis machining machine, in particular a micro machining machine with a reduced workspace.

### DISCLOSURE OF THE INVENTION

The purpose of the invention is achieved by a machining machine comprising:
a frame,
a tool spindle designed to carry a tool,
a main workpiece holder designed to hold a workpiece, movable relative to the tool spindle, in translation along three axes X, Y, and Z that are not parallel to each other, and in rotation along an axis B, the main workpiece holder being mounted on a cradle integral with a hollow shaft that is movable in rotation around the axis B,
a secondary workpiece support that can be actuated by control means between a position of engagement in contact with the workpiece and a position of disengagement without contact with the workpiece. The machine according to the invention also comprises a finishing unit housed at least partially in the hollow shaft and extending through an opening in the cradle, said finishing unit comprising a sliding rod movable in translation along the axis B between a retracted position and an extended position, the secondary workpiece support being kinematically connected to the sliding rod.

This arrangement allows a secondary workpiece holder to be incorporated to perform a reworking operation on the same machining spindle with limited impact on machining capabilities and accessibility to the machining area when the secondary workpiece holder is not in use, thanks to the retraction of the secondary workpiece holder and the integration of the finishing unit into the rotation shaft without cluttering the workspace.

According to one advantageous aspect, the secondary workpiece support is mounted on the sliding rod.

This arrangement allows the secondary workpiece support to be brought close to the workpiece held in the main workpiece holder and the secondary workpiece support to be retracted so as not to interfere with the initial machining operations.

According to one advantageous aspect, the secondary workpiece support is mounted on the cradle.

In this configuration, the sliding rod constitutes the control means that allow the secondary workpiece support to be engaged and withdrawn from contact with the workpiece.

According to one advantageous aspect, the X, Y, and Z axes are perpendicular, with the Z axis being vertical.

According to one advantageous aspect, the B axis is parallel to the Y axis.

According to one advantageous aspect, the tool spindle is mounted on a first slide that can be moved along the Z axis with reference to a second slide that can be moved along the X axis with reference to the frame, and in which the hollow shaft is mounted so that it can rotate on a third slide that can be moved in translation with reference to the frame along the Y axis.

According to an advantageous aspect, the main workpiece holder is fixed to a workpiece spindle mounted on the cradle and rotatable about an axis C perpendicular to the axis B.

According to an advantageous aspect, the secondary workpiece support is a secondary workpiece holder comprising gripping means capable of gripping a workpiece held in the main workpiece holder when the sliding rod is in the extended position and the cradle is in a transfer position.

This arrangement makes it possible to transfer the workpiece to the secondary workpiece holder for finishing.

According to a particularly advantageous aspect, the finishing unit comprises pivoting means capable of pivoting the sliding rod in rotation about axis B between a transfer orientation and a machining orientation spaced apart by a predetermined value of between 0 and 180°.

This arrangement allows the workpiece to be completely turned over to present the last face to be machined in an optimal orientation with respect to the tool spindle.

According to an advantageous aspect of the invention, the sliding rod is in the transfer orientation when it is in its extended position and in the machining orientation when it is in its retracted position.

According to an advantageous aspect of the invention, the pivoting means defining the angular position of the sliding rod relative to the cradle consist of a cam and a cam follower, one of which is integral with the sliding rod and the other with the cradle.

According to an advantageous aspect of the invention, the secondary workpiece support is a blank holder designed to bear on a workpiece.

According to another advantageous aspect of the invention, the secondary workpiece support is a rotary support designed to support a workpiece intended for turning

This arrangement allows a trimming operation to be performed on the workpiece.

### BRIEF DESCRIPTION OF THE DRAWINGS

Further details of the invention will become clearer upon reading the following description, which refers to the accompanying drawings, in which:

FIG. 1 shows a view of the main elements of a machine according to the invention,

FIG. 2 shows an exploded view of elements of the invention,

FIGS. 3 to 5 show a first embodiment of the invention in three successive states,

FIGS. 6 to 8 show the finishing unit of the first embodiment in a folded position, an intermediate position, and an extended position, respectively,

FIGS. 9 and 10 show a second embodiment of the invention in a folded position and an extended position, respectively,

FIGS. 11 to 12 show a third embodiment of the invention in a folded position and an extended position, respectively.

### EMBODIMENTS OF THE INVENTION

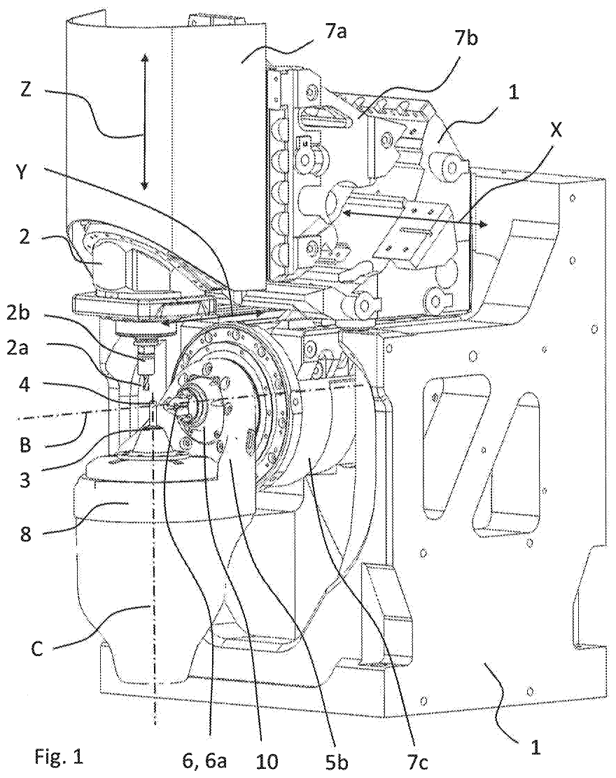

The present invention relates to a machining machine comprising at least four machining axes, namely three translational axes and at least one rotational axis. FIG. 1 shows a view of the main components of such a machining machine. This structure is designed to be placed in a protective casing and to operate with various feed and control devices.

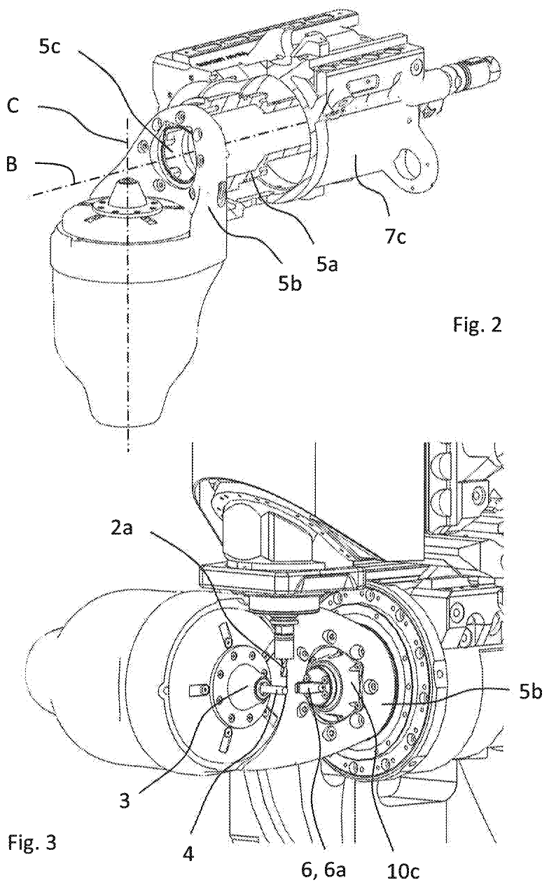

The machining machine comprises a frame 1 whose high rigidity contributes to the precision and repeatability of the machining. The frame 1 is mounted on a support 1a. The machine also comprises a tool spindle 2 designed to carry a tool 2a via a tool holder 2b, as well as a main workpiece holder 3 designed to hold a workpiece 4. The main workpiece holder 3 is movable relative to the tool spindle 2 according to at least four degrees of freedom: three degrees of freedom in translation along three axes X, Y, and Z that are not parallel to each other, and at least one degree of freedom in rotation along an axis B. To this end, the main workpiece holder 3 is mounted on a cradle 5b integral with a hollow shaft 5a that is movable in rotation about the axis B and visible in FIG. 2.

In the example shown, the X, Y, and Z axes are perpendicular to each other, with the Z axis being vertical and the X and Y axes therefore being horizontal. The B axis is parallel to the Y axis. According to the particular configuration shown, the tool spindle 2 is mounted so that it can move in translation with respect to the frame 1 along the X and Z axes, the tool spindle 2 being mounted on a first slide 7a that can move along the Z axis with respect to a second slide 7b that can move along the X axis with respect to the frame 1. The main workpiece holder 3 is mounted on the cradle 5b integral with the hollow shaft 5a, which is itself mounted so as to be movable in rotation with respect to a third slide 7c movable with respect to the frame 1 along a horizontal Y-axis perpendicular to the X-axis. In the example shown, the B axis is parallel to the Y axis, with the hollow shaft 5a mounted so that it pivots in the third slide 7c, so that the main workpiece holder can rotate and translate with respect to the frame along the B axis. Of course, the invention is not limited to this particular machine architecture; the three slides providing the three translational movements could, for example, be mounted in series between the frame and the tool spindle.

In the embodiment shown, the machine also has a fifth machining axis. In this case, the main workpiece holder 3 is not integral with the cradle 5b but is attached to a workpiece spindle 8 mounted on the cradle 5b and rotatable about an axis C perpendicular to axis B.

In order to be able to complete the machining of the workpiece 4 without having to transfer it to another station, the machine also includes a secondary workpiece support 6. The secondary workpiece support 6 can be actuated by control means between an engagement position in contact with the workpiece 4 and a release position without contact with the workpiece. The secondary workpiece support 6 can take several forms depending on the type of machining to be performed to finish the workpiece.

The machine also includes a finishing unit 10 housed at least partially in the hollow shaft 5a and extending through an opening 5c in the cradle. The finishing unit 10 comprises a sliding rod 11 that can move in translation along axis B between a retracted position and an extended position. In the first embodiment, the secondary workpiece support 6 is mounted on the sliding rod 11. When the sliding rod 11 is in the retracted position, as can be seen in FIGS. 1, 3, 9, and 11, the secondary workpiece support 6 is set back and does not interfere with the relative movements of the tool and the workpiece during the first machining phase. Nor does it limit the angular amplitude of the cradle's rotation around axis B or accessibility to the machining area. Furthermore, the finishing unit extending along axis B has only a slight effect on the moment of inertia of the assembly rotating around axis B.

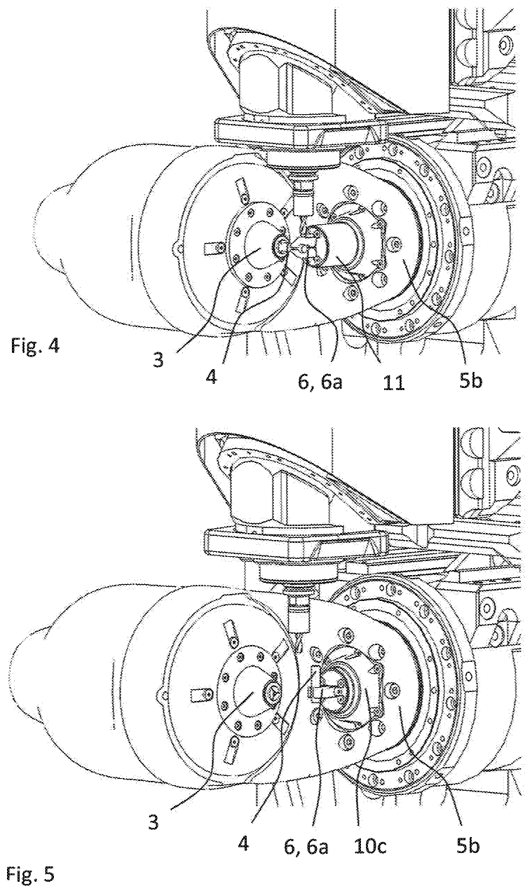

In a first embodiment shown in FIGS. 3 to 8, the secondary workpiece support 6 is a secondary workpiece holder 6a comprising gripping means, typically a clamp that can be actuated by control means to control its opening and closing. Once the sliding rod 11 is in the extended position and the main workpiece holder 3 is in a predetermined transfer position, the secondary workpiece holder 6a is able to grasp the workpiece held in the main workpiece holder 3. In the example shown, the transfer position corresponds to a 90° tilt of the cradle 5b, as in the configuration shown in FIGS. 3 and 4. The workpiece held in the two workpiece holders can thus be cut using a suitable tool, with the final workpiece remaining in the secondary workpiece holder 6a. The portion remaining in the main workpiece holder 3 can be removed or, in the case of a bar, moved through the main workpiece holder 3 to start a new workpiece. The secondary workpiece holder 6a is capable of holding the workpiece 4 when the slide 11 returns to its retracted position as shown in FIG. 5 in order to machine the last face and remove a completely finished workpiece.

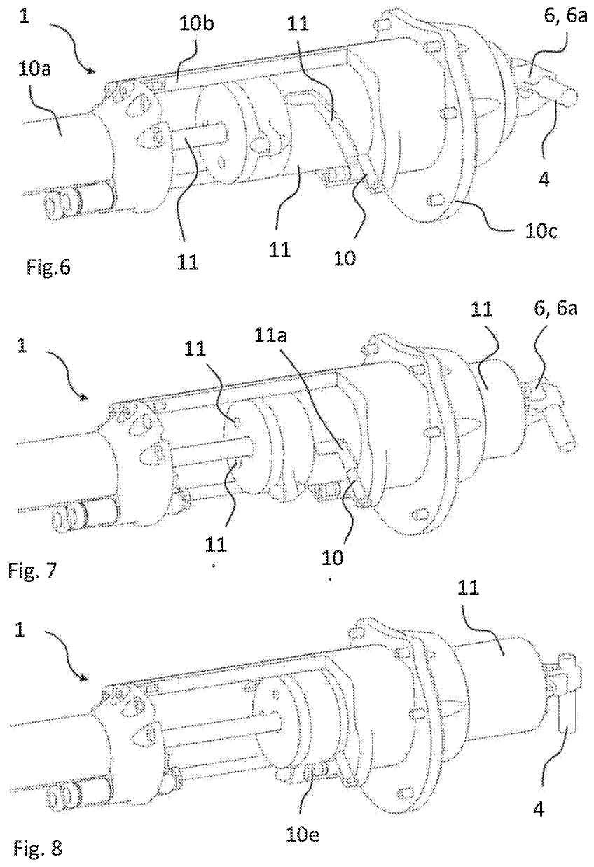

FIGS. 6 to 8 show a finishing unit 10 in different positions of the sliding rod 11. The finishing unit 10 is attached to the cradle 5b by means of a cover 10c so that the finishing unit 10 is housed at least partially in the hollow shaft 5a and extends through the opening 5c of the cradle in the direction of axis B. The cover 10c is integral with a cylindrical body 10b, at the end of which an actuator 10a, typically a motor or a cylinder, is attached. The actuator 10a is arranged to move the sliding rod 11 in the cylindrical body 10b by means of a rod 11b so that the sliding rod 11 can move in translation along axis B between a retracted position and an extended position shown in FIGS. 6 and 8, respectively, with FIG. 7 showing an intermediate position.

Openings 11c, 11d are provided in the sliding rod 11 for the passage of flexible elements intended to supply control means for actuating the secondary workpiece holder 6a to grip, hold or release a workpiece 4.

Stops 10e are provided to limit the travel of the sliding rod and to position the secondary part support precisely and repeatably, in translation and rotation, in the folded and unfolded positions of the sliding rod 11.

In the first embodiment, the sliding rod 11 is also rotatable about axis B, forming a sliding pivot connection with the cylindrical body 10b. In addition, the finishing unit comprises pivoting means capable of pivoting the sliding rod 11 in rotation about axis B between a transfer orientation and a machining orientation spaced apart by a predetermined value of between 0 and 180°.

In the example shown, the sliding rod 11 is in its transfer position when it is both in its extended position and in its transfer orientation, while it is in its machining position when it is both in its retracted position and in its machining orientation.

The pivoting means may take several forms. A rotary cylinder mounted in series on the linear actuator, or a combined rotary electromagnetic linear actuator, may be provided. The slide and pivot connections of the sliding rod 11 with reference to the cylindrical body 10b may also be connected to form, for example, a helical connection.

In the example shown, the degrees of freedom in translation and rotation of the sliding rod 11 with respect to the cylindrical body 10b and therefore to the cradle 5b with which it is integral are linked by a cam system. The pivoting means defining the angular position of the sliding rod 11 in relation to the cradle 5b consist of a cam 11a and a cam follower 10d, one integral with the sliding rod and the other integral with the cradle. In the particular embodiment shown, cam 11a is a groove formed on sliding rod 11 in which the end of a pin 10d fixed to cylindrical body 10b is housed. A groove could just as easily be formed in the inner wall of the cylindrical body 10b and a pin fixed at the sliding rod 11. By moving the sliding rod from the extended position to the retracted position along axis B, pin 10d follows the cam path formed by groove 11a, which forces sliding rod 11 to pivot around axis B by a predetermined amount defined by the shape of the cam. In the example shown, the cam is arranged so that the angular positions around axis B of the slide in its extended and retracted positions are spaced 90°apart.

The rotation of the sliding rod 11 combined with its translation along axis B explains the change in orientation of the secondary workpiece holder 6a between the extended position of the sliding rod shown in FIG. 4 and its retracted position shown in FIGS. 3 and 5. Adding the rotation of the cradle 5b to the transfer position and the rotation of the sliding rod when it returns to its folded position, we obtain a total rotation of 180° of the workpiece 4 relative to its original position shown in FIG. 1. The complete reversal of the workpiece allows the last face to be machined to be presented in an optimal orientation, orthogonal to the direction of the machining spindle 2, and thus enables complete machining along the four axes X, Y, Z, and B when the sliding rod 11 is in the folded position shown in FIG. 5.

A skilled in the art person will know how to modify the machine's settings according to the geometry of the workpiece. To increase the angular amplitude of the cradle when machining the last face, it is possible to provide for a specific transfer angle whose value is within the tilting amplitude of the cradle 5b, i.e., approximately plus or minus 120°. For example, a transfer angle of 60° can be set, and a rotation of the slide of 120° between the transfer orientation and the machining orientation.

The installation in the hollow shaft 5a of a finishing unit 10 equipped with a retractable secondary workpiece support makes it possible to finish the workpiece by taking advantage of all the degrees of freedom of the machine, including rotation around axis B, without significantly impacting the initial machining capabilities in terms of the amplitude of the relative movements of the tool and the part, the accessibility of the machining area, and the inertia of the cradle.

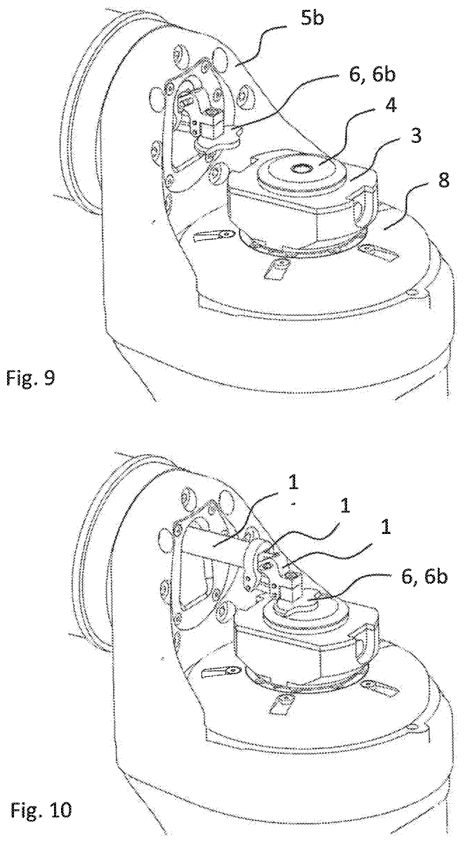

FIGS. 9 and 10 show a second embodiment of the invention in which the secondary workpiece support 6 is a blank holder 6b designed to rest on a workpiece 4 mounted on a main workpiece holder 3. A blank holder allows a part of the workpiece to be supported in order to hold it in place and machine the areas that remain accessible. In the second embodiment, the blank holder 6b is mounted at the end of a sliding rod 11 capable of moving parallel to axis B between a retracted position and an extended position. Once the sliding rod is in the extended position shown in FIG. 10, a cylinder 12, actuated by control means located in the recovery module, drives a flange 13 on which the blank holder 6b is mounted. In the example shown, the flange 13 is mounted on a deformable parallelogram so that the contact surfaces of the blank holder and the workpiece 4 remain parallel. The blank holder 6b can thus be moved in a circular translation with a component orthogonal to the workpiece mounting plane until it comes into contact with the workpiece. Other solutions are possible; the blank holder could simply be pivoted at the end of the sliding rod and its rotation controlled by the cylinder 12. In this case, the blank holder would have a circular trajectory also having a component orthogonal to the plane of the workpiece.

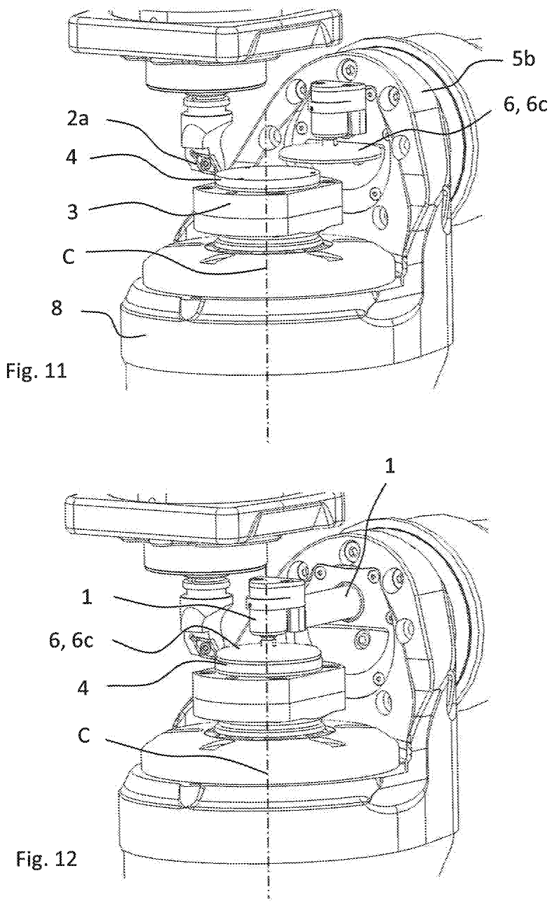

FIGS. 11 and 12 show a third embodiment of the invention in which the secondary workpiece support is a rotary support 6c designed to support a workpiece intended for turning. The main workpiece holder 3 is mounted on a workpiece spindle 8 to be driven in rotation around axis C. The main workpiece holder 3 holds a workpiece 4 on which various machining operations can be performed when the secondary workpiece support is in the retracted position as shown in FIG. 11. To obtain a surface of revolution around the circumference of the workpiece, the workpiece is cut by rotating it against a chisel-type tool 2a. During the cutting operation, it is necessary to hold the workpiece with a secondary workpiece support exerting pressure perpendicular to the mounting plane in a similar manner to the blank holder 6b. As the part is rotated, the rotary support 6c is free to rotate around axis C. A short-stroke cylinder 14 is mounted at the end of the sliding rod 11 to move the rotary support 6c orthogonally to the mounting plane until it comes into contact with the part to be machined.

In the examples presented, specific control means are used to actuate the secondary workpiece support. In alternative solutions not shown, the control means are directly the sliding rod 11, the workpiece support being actuated by the relative movement of the sliding rod with respect to the cradle. The workpiece support can, for example, be pivoted on the sliding rod or mounted on a flange 13 similar to that shown in FIGS. 9 and 10, being kinematically connected to the cradle so that the movement of the sliding rod causes the workpiece support to move and engage with the workpiece. In the case of a clamp, the machine may be arranged so that the movement of the sliding rod towards its extended position causes the clamp to move and close. Conversely, the workpiece support could be mounted on the cradle and kinematically connected to the sliding rod. In the case of a blank holder, it can be actuated by the sliding rod so as to be engaged on the workpiece when the sliding rod is moved. The blank holder can thus be pivoted on the sliding rod and kinematically connected to the cradle or, conversely, pivoted on the cradle and kinematically connected to the sliding rod. In the examples shown, the extended position of the sliding rod corresponds to the position in which the workpiece support is able to engage with the workpiece. In the case where the sliding rod is the means of controlling the workpiece support, the extended position of the sliding rod may correspond to the retracted position of the workpiece support and the retracted position of the sliding rod may correspond to the engaged position of the workpiece support.

The various examples presented illustrate, in a non-limiting manner, different solutions for integrating a secondary workpiece support 6 into the heart of a multi-axis machine in order to perform finishing operations on the workpiece, taking advantage of all the machine's axes while having a minimal impact on machining capabilities when only the main workpiece holder 3 is used and on accessibility to the machining area.

1. Machine for machining workpieces comprising:
a frame (1),
a tool spindle (2) designed to carry a tool (2a),
a main workpiece holder (3) designed to hold a workpiece (4), movable relative to the tool spindle, in translation along three non-parallel axes X, Y and Z, and in rotation along an axis B, the main workpiece holder (3) being mounted on a cradle (5b) integral with a hollow shaft (5a) rotatable about axis B,
a secondary workpiece holder (6) operable by control means between an engagement position in contact with the workpiece (4) and a disengagement position out of contact with the workpiece,
wherein the machine also comprises a finishing unit (10) housed at least partially in the hollow shaft (5a) and extending through an opening (5c) in the cradle (5b), said finishing unit (10) comprising a sliding rod (11) translationally movable along axis B between a folded position and a deployed position, the secondary workpiece support (6) being kinematically connected to the sliding rod (11).

2. Machine according to claim 1 wherein the secondary workpiece holder (6) is mounted on the sliding rod (11).

3. Machine according to claim 1 in which the secondary workpiece holder (6) is mounted on the cradle (5b).

4. Machine according to claim 1 wherein the X, Y and Z axes are perpendicular, the Z axis being vertical.

5. Machine according to claim 1 wherein the B axis is parallel to the Y axis.

6. Machine according to claim 1 wherein the tool spindle (2) is mounted on a first slide (7a) movable along the Z axis with reference to a second slide (7b) movable along the X axis with reference to the frame (1) and in which the hollow shaft (5a) is mounted so as to be rotatable on a third slide (7c) movable in translation with reference to the frame (1) along the Y axis.

7. Machine according to claim 1 wherein the main workpiece holder (3) is attached to a workpiece spindle (8) mounted on the cradle (5b) and rotatable about an axis C perpendicular to axis B.

8. Machine according to claim 1 wherein the secondary workpiece support (6) is a secondary workpiece holder (6a) comprising gripping means capable of gripping a workpiece held in the main workpiece holder (3) when the sliding rod (11) is in the deployed position and the cradle (5b) is in a transfer position.

9. Machine according to the preceding claim wherein the finishing unit (10) comprises pivoting means capable of pivoting the sliding rod (11) in rotation about the B axis between a transfer orientation and a machining orientation spaced apart by a given value between 0 and 180°.

10. Machine according to the preceding claim wherein the sliding rod (11) is in the transfer orientation when in its extended position and in the machining orientation when in its folded position.

11. Machine according to the preceding claim wherein the pivoting means defining the angular position of the sliding rod (11) with reference to the cradle consist of a cam (11a) and a cam follower (10d), one of which is integral with the sliding rod (11) and the other with the cradle (5b).

12. Machine according to claim 1 wherein the secondary workpiece support (6) is a blank holder (6b) designed to bear on a workpiece.

13. Machine according to claim 7 wherein the secondary workpiece support (6) is a rotating support (6c) designed to support a workpiece intended for turning.

14. Machine according to claim 10 wherein the actuation of the control means causes a displacement of the secondary workpiece support (6, 6b, 6c) having a component orthogonal to the positioning plane of the workpiece.
